(19) United States
(12) Patent Application Publication
(10) Pub. No.: US 2025/0237922 A1
(43) Pub. Date: Jul. 24, 2025

(54) FLEXIBLE SEGMENTED ELECTRO-OPTIC DISPLAYS AND METHODS OF MANUFACTURE

(71) Applicant: E INK CORPORATION, Billerica, MA (US)

(72) Inventor: George G. HARRIS, Woburn, MA (US)

(21) Appl. No.: 18/985,619

(22) Filed: Dec. 18, 2024

Related U.S. Application Data
(60) Provisional application No. 63/622,686, filed on Jan. 19, 2024.

(51) Int. Cl. G02F 1/16755; G02F 1/167; G02F 1/1677

(52) U.S. Cl. CPC G02F 1/16755; G02F 1/167; G02F 1/1677

(57) ABSTRACT

A flexible segmented electro-optic display and method of manufacture are disclosed. The display includes an electroactive layer having a front viewing side and an opposite rear side. The electroactive layer includes an encapsulated electrophoretic medium. A light transmissive common electrode layer is superposed on the front viewing side of the electroactive layer. A plurality of display segment electrodes are directly adjacent the rear side of the electroactive layer. Each of the display segment electrodes is associated with an adjacent portion of the encapsulated electrophoretic medium. A processor die is electrically connected to each of the plurality of display segment electrodes to apply voltages to selected display segment electrodes to drive the respective associated portions of the encapsulated electrophoretic medium among different optical states. A protective seal encapsulates the electroactive layer, the light transmissive common electrode layer, the plurality of display segment electrodes, and the processor die.

### CROSS REFERENCE TO RELATED APPLICATIONS

This application claims priority from U.S. Provisional Patent Application No. 63/622,686 filed on Jan. 19, 2024 entitled FLEXIBLE SEGMENTED ELECTRO-OPTIC DISPLAYS AND METHODS OF MANUFACTURE, which is hereby incorporated by reference in its entirety.

### BACKGROUND

The present application relates generally to flexible segmented electro-optic displays and methods of manufacture. More particularly, the application relates to flexible segmented electrophoretic displays having an arrangement of display segment electrodes printed directly adjacent to one side of the device's electroactive layer, rather than in a backplane laminated to the electroactive layer.

The electro-optic displays can comprise encapsulated electrophoretic media as well as various other types of electro-optic media that are “solid” in the sense that they have solid external surfaces, although the media may, and often do, have internal cavities that contain a fluid (either liquid or gas). Such “solid electro-optic displays” include encapsulated electrophoretic displays, encapsulated liquid crystal displays, and other types of displays discussed below.

Electro-optic displays comprise a layer of electro-optic material, a term that is used herein in its conventional meaning in the imaging art to refer to an electroactive material having at least first and second display states differing in at least one optical property, the material being changed from its first to its second display state by application of an electric field to the material. Although the optical property is typically color perceptible to the human eye, it may be another optical property, such as optical transmission, reflectance, luminescence, or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an electrical addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Pat. No. 7,170,670 that some particle-based electrophoretic displays capable of gray scale are stable, not only in their extreme black and white states, but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, e.g., in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) that have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, e.g., an electrochromic medium in the form of a nanochromic film comprising an electrode formed at least in part from a semi-conducting metal oxide and a plurality of dye molecules capable of reversible color change attached to the electrode; see, e.g., O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, e.g., in U.S. Pat. Nos. 6,301,038; 6,870.657; and 6,950,220. This type of medium is also typically bistable.

Particle-based electrophoretic displays, in which charged particles move through a suspending fluid under the influence of an electric field, are another type of electro-optic display. Such displays have been the subject of intense research and development for a number of years. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays can settle, resulting in inadequate service-life for these displays.

As noted above, electrophoretic media require the presence of a fluid. In most prior art electrophoretic media, this fluid is a liquid, but electrophoretic media can be produced using gaseous fluids; see, e.g., Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Patent Application Publication No. 2005/0001810; European Patent Applications 1,462,847; 1,482,354; 1,484,635; 1,500,971; 1,501,194; 1,536,271; 1,542,067; 1,577,702; 1,577,703; and 1,598,694; and International Applications WO 2004/090626; WO 2004/079442; and WO 2004/001498. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives: see, e.g., U.S. Pat. Nos. 7,002,728 and 7,679,814;
(b) Capsules, binders and encapsulation processes: see, e.g., U.S. Pat. Nos. 6,922,276 and 7,411,719;
(c) Microcell structures, wall materials, and methods of forming microcells: see, e.g., U.S. Pat. Nos. 7,072,095 and 9,279,906;
(d) Methods for filling and sealing microcells: see, e.g., U.S. Pat. Nos. 7,144,942 and 7,715,088;
(e) Films and sub-assemblies containing electro-optic materials: see, e.g., U.S. Pat. Nos. 6,982,178 and 7,839,564;
(f) Backplanes, adhesive layers and other auxiliary layers and methods used in displays: see, e.g., U.S. Pat. Nos. 7,116,318 and 7,535,624;
(g) Color formation color adjustment: see, e.g., U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Application Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays: see, e.g., U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Application Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777 (these patents and applications may hereinafter be referred to as the MEDEOD (MEthods for Driving Electro-optic Displays) applications);
(i) Applications of displays: see, e.g., U.S. Pat. Nos. 7,312,784 and 8,009,348; and
(j) Non-electrophoretic displays: see, e.g., U.S. Pat. No. 6,241,921 and U.S. Patent Application Publication Nos. 2015/0277160, 2015/0005720, and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules, but instead are retained within a plurality of cavities formed within a carrier medium, typically a polymeric film. See, e.g., U.S. Pat. Nos. 6,672,921 and 6,788,449.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

Other types of electro-optic materials may also be used in various embodiments. Of particular interest, bistable ferroelectric liquid crystal displays (FLCs) are known in the art.

Although electrophoretic media are often opaque (since, e.g., in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, e.g., the aforementioned U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see, e.g., U.S. Pat. No. 4,418,346.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

An electro-optic display normally comprises a layer of electro-optic material and at least two other layers disposed on opposed sides of the electro-optic material, one of these two layers being an electrode layer. In most such displays both the layers are electrode layers, and one or both of the electrode layers are patterned to define the pixels of the display. In most electro-optic displays, at least one of the electrode layers is light-transmissive. In a passive matrix device, one electrode layer may be patterned into elongate row electrodes while the other electrode layer is patterned into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display. In another type of electro-optic display intended for use with a stylus, print head, or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

The manufacture of a three-layer electro-optic display normally involves at least one lamination operation. For example, several of the aforementioned MIT and E Ink patents and applications describe a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as an one electrode of the final display) on a plastic film (e.g., polyethylene terephthalate (PET)), the capsules/binder coating being subsequently dried to form a coherent layer of the electrophoretic medium firmly adhered to the substrate. Separately, a backplane containing an array of pixel electrodes and an appropriate arrangement of conductors to connect the pixel electrodes to drive circuitry is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one form of such a process, the backplane is itself flexible and is prepared by printing the pixel electrodes and conductors on a plastic film or other flexible substrate. A lamination technique for mass production of displays by this process is roll-to-roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

As discussed in the aforementioned U.S. Pat. No. 6,982,178, many of the components used in solid electro-optic displays and the methods used to manufacture such displays are derived from technology used in liquid crystal displays (LCDs), which are also electro-optic displays, though using a liquid medium. However, the methods used for assembling LCDs cannot be used with solid electro-optic displays. LCDs are normally assembled by forming the backplane and front electrode on separate glass substrates, then adhesively securing these components together leaving a small aperture between them, placing the resultant assembly under vacuum, and immersing the assembly in a bath of the liquid crystal, so that the liquid crystal flows through the aperture between the backplane and the front electrode. Finally, with the liquid crystal in place, the aperture is sealed to provide the final display.

Segmented electro-optic displays include an arrangement of display segment electrodes that can be individually controlled to render a desired image. In prior art segmented electro-optic displays, the display segment electrodes are formed in the backplane of the display, and are selectively driven to change the optical states of adjacent portions of the electro-optic medium. The display segment electrodes are patterned on a substrate in the backplane, which is then laminated with an adhesive to the frontplane laminate containing the electro-optic medium. The thickness of the substrate in addition to the thickness of the frontplane laminate adhesive reduces the flexibility of the device by adding significant bulk and stiffness to the overall structure. A need exists for a segmented electro-optic device with increased flexibility and a method of manufacturing such device.

### SUMMARY OF THE INVENTION

A flexible segmented electrophoretic display in one aspect of the invention includes an electroactive layer having a front viewing side and an opposite rear side. The electroactive layer includes an encapsulated electrophoretic medium. A light transmissive common electrode layer is superposed on the front viewing side of the electroactive layer. A plurality of display segment electrodes are directly adjacent the rear side of the electroactive layer. Each of the display segment electrodes is associated with an adjacent portion of the encapsulated electrophoretic medium. A processor die is electrically connected to each of the plurality of display segment electrodes to apply voltages to selected display segment electrodes to drive the respective associated portions of the encapsulated electrophoretic medium among different optical states. A protective seal encapsulates at least the electroactive layer, the light transmissive common electrode layer, the plurality of display segment electrodes, and the processor die.

A method of constructing a flexible segmented electrophoretic display according to one aspect of the invention includes the steps of: (a) forming an electroactive layer comprising an encapsulated electrophoretic medium on one side of a light transmissive common electrode layer; (b) applying a viewing side protective seal layer on an opposite side of the light transmissive common electrode layer; (c) printing a plurality of display segment electrodes directly adjacent a side of the electroactive layer opposite the light transmissive common electrode layer, wherein each of the display segment electrodes is associated with an adjacent portion of the encapsulated electrophoretic medium; (d) bonding a processor die proximate to the plurality of display segment electrodes; (e) printing interconnects electrically connecting the processor die to each of the plurality of display segment electrodes to enable the processor die to selectively apply voltages to the display segment electrodes to drive the respective associated portions of the encapsulated electrophoretic medium among different optical states; and (f) applying a rear protective seal layer over the processor die and the interconnects such that the rear protective seal layer and the viewing side protective seal layer encapsulate the electroactive layer, the light transmissive common electrode layer, the plurality of display segment electrodes, the interconnects, and the processor die.

A method of constructing a flexible segmented electrophoretic display according to another aspect of the invention includes the steps of: (a) forming an electroactive layer comprising an encapsulated electrophoretic medium on one side of a conductive integrated barrier layer; (b) printing a plurality of display segment electrodes directly adjacent a side of the electroactive layer opposite the conductive integrated barrier layer, wherein each of the display segment electrodes is associated with an adjacent portion of the encapsulated electrophoretic medium; (c) bonding a processor die proximate to the plurality of display segment electrodes; (e) printing interconnects electrically connecting the processor die to each of the plurality of display segment electrodes to enable the processor die to selectively apply voltages to the display segment electrodes to drive the respective associated portions of the encapsulated electrophoretic medium among different optical states; and (d) applying a rear protective seal layer over the processor die and the interconnects such that the rear protective seal layer and the integrated barrier layer encapsulate the electroactive layer, the plurality of display segment electrodes, the interconnects, and the processor die.

In accordance with one or more embodiments, the encapsulated electrophoretic medium comprise an electrophoretic medium encapsulated in microcapsules dispersed in a polymer binder or contained in sealed microcells.

In accordance with one or more embodiments, the processor die has a thickness of less than 100 um, preferably less than 50 um.

In accordance with one or more embodiments, there is no air gap between the processor die and the protective seal.

In accordance with one or more embodiments, the processor die is secured to the electrophoretic display by a flip-chip bonding process.

In accordance with one or more embodiments, the protective seal comprises a low water vapor transmission rate (WVTR) edge seal resin.

In accordance with one or more embodiments, the processor die is mounted on a flexible carrier film providing a fanout of processor die connections to facilitate electrical connections to the display segment electrodes.

In accordance with one or more embodiments, the processor die is electrically connected to each of the plurality of display segment electrodes by interconnects comprising printed conductive ink.

In accordance with one or more embodiments, the interconnects are printed using an impulse printing process.

In accordance with one or more embodiments, the display further comprises additional interconnects electrically connecting the processor die to power and control input contacts at an edge of the protective seal.

In accordance with one or more embodiments, the additional interconnects comprise conductive carbon, silver, or copper.

In accordance with one or more embodiments, the power and control input contacts comprise power, ground, data, and clock inputs.

In accordance with one or more embodiments, the protective seal comprises a rear protective seal facing the rear side of the electroactive layer and a front protective seal facing the front viewing side of the electroactive layer.

In accordance with one or more embodiments, the front protective seal and the rear protective seal form barrier edge seal for inhibiting ingress of moisture or contaminants

In accordance with one or more embodiments, the barrier edge seal comprises a pinched edge seal.

In accordance with one or more embodiments, the plurality of display segment electrodes are printed directly on the electroactive layer using inkjet or screen printing processes.

In accordance with one or more embodiments, the display further comprises a color filter array between the electroactive layer and the light transmissive common electrode layer.

In accordance with one or more embodiments, the display segment electrodes comprise conductive carbon.

In accordance with one or more embodiments, the display further comprises a dielectric layer formed selectively over the display segment electrodes, and wherein the processor die is bonded on the dielectric layer.

In accordance with one or more embodiments, the display further comprises an encapsulant between the protective seal and the processor die and the interconnects.

In accordance with one or more embodiments, the plurality of display segment electrodes are directly on the rear side of the electroactive layer without any adhesive layer therebetween.

In accordance with one or more embodiments, the plurality of display segment electrodes are directly on the rear side of the electroactive layer without any substrate therebetween.

### BRIEF DESCRIPTION OF DRAWINGS

Additional details of one or more embodiments of the subject matter described in this specification are set forth in the accompanying drawings and the description below. Other features, aspects, and advantages of the subject matter will become apparent from the descriptions contained herein and the accompanying drawings. It should be stressed that the accompanying drawings are schematic and not to scale. In particular, for ease of illustration, the thicknesses of the various layers in the drawings do not correspond to their actual thicknesses. Also, the thicknesses of the various layers are out of scale relative to their lateral dimensions. Generally, elements of similar structures are annotated with like reference numerals for illustrative purposes throughout the drawings. However, the specific properties and functions of elements in different embodiments may not be identical. Further, the drawings are only intended to facilitate the description of the subject matter. The drawings do not illustrate every aspect of the described embodiments and do not limit the scope of the present disclosure or claims.

FIG. 1 is a schematic diagram showing an exemplary prior art segmented electro-optic device.

FIG. 2 is a schematic cross-section view showing an exemplary front plane laminate of the prior art segmented electro-optic device.

FIGS. 3A and 3B are cross-section and plan views, respectively, schematically illustrating an exemplary flexible segmented electrophoretic display having a dispensed edge seal in accordance with one or more embodiments.

FIG. 4 is a cross-section view schematically illustrating an exemplary flexible segmented electrophoretic display having a pinched edge seal in accordance with one or more further embodiments.

FIG. 5 is a cross-section view schematically illustrating an exemplary flexible segmented electrophoretic display having an integrated front barrier with a dispensed edge seal in accordance with one or more further embodiments.

### DETAILED DESCRIPTION

Various embodiments disclosed herein relate to a flexible segmented electrophoretic display having a plurality of display segment electrodes directly adjacent to one side of the device's electroactive layer, rather than in a backplane laminated to the electroactive layer. Such a display provides improved flexibility and other advantages as discussed below.

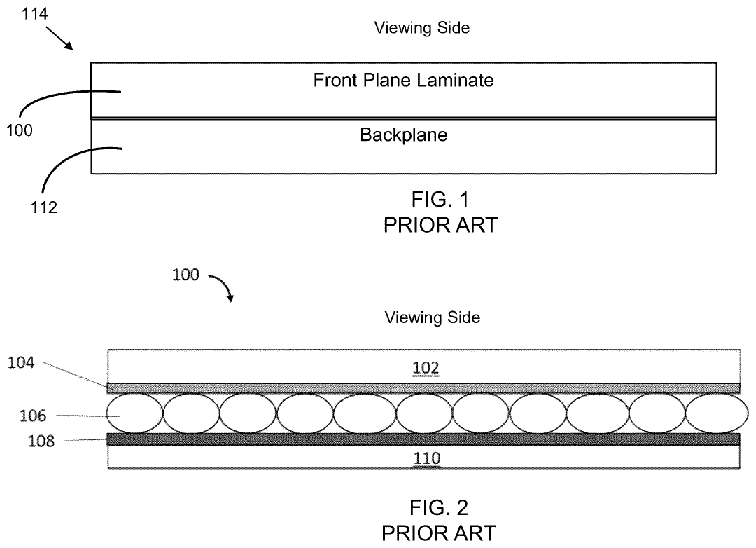

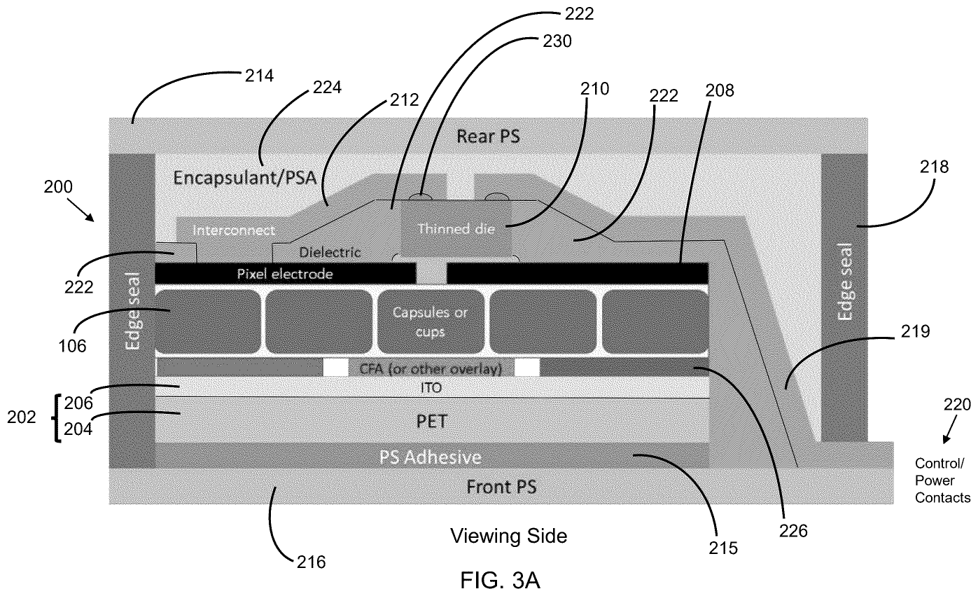

FIG. 1 schematically illustrates a prior art segmented electro-optic device 114 comprising a backplane 112 laminated to a frontplane laminate 100. The frontplane laminate 100 includes an encapsulated electrophoretic or other electro-optic medium 106 as shown in FIG. 2. The backplane 112 comprises a rigid or flexible layer having a plurality of display segment electrodes deposited thereon (e.g., carbon electrodes on a PET layer or copper electrodes on a Polyimide layer or on an FR-4 glass-reinforced epoxy laminate). The display segment electrodes are each associated with an adjacent portion of the encapsulated electro-optic medium such that voltages selectively applied to the display segment electrodes drive the respective associated portions of the encapsulated electrophoretic medium between different optical states.

The backplane 112 can include electronics for addressing the display, or such electronics may be provided in a unit separate from the backplane. The backplane has barrier properties to prevent ingress of moisture and other contaminants, particularly through the non-viewing side of the display. (The display is of course normally viewed from the side remote from the backplane.)

The frontplane laminate 100 shown in FIG. 2 is also described in U.S. Pat. No. 10,503,041. The frontplane laminate 100 includes, in order, a front plane light-transmissive substrate 102, a light-transmissive electrically-conductive layer 104 in contact with the inner surface of the front plane light-transmissive substrate 102, a layer of an electro-optic medium (i.e., an electroactive layer) 106, an adhesive layer 108, and a release sheet 110.

The front plane light-transmissive substrate 102 can comprise a PET layer, and the light-transmissive electrically-conductive layer 104 can comprise an ITO layer. Such materials are commercially available in large rolls, e.g., from Saint-Gobain. The light-transmissive electrically-conductive layer 104 is applied to the light-transmissive substrate 102, which is usually flexible, in the sense that the substrate can be manually wrapped around a drum, e.g., 10 inches (254 mm) in diameter without permanent deformation.

The term “light-transmissive” is used herein consistent with its conventional meaning in the art of electro-optic displays and in the aforementioned patents and published applications to mean that the layer thus designated transmits sufficient light to enable an observer, looking through that layer, to observe the change in display states of the electro-optic medium, which will normally be viewed through the electrically-conductive layer 104 and adjacent substrate 102. In instances where the electro-optic medium 106 displays a change in reflectivity at non-visible wavelengths, the term “light-transmissive” should of course be interpreted to refer to transmission of the relevant non-visible wavelengths. The substrate 102 can be manufactured from a glass or a polymeric film, e.g., PET, and may have a thickness in the range from about 20 μm to about 650 μm, more typically about 50 μm to about 250 μm. The electrically-conductive layer 104 is typically a thin layer of a so-called “transparent conducting oxide” such as aluminum oxide, zinc oxide, indium zinc oxide, or indium-tin-oxide, or the electrically-conductive layer 104 may include a conductive polymer, such as poly(3,4-ethylenedioxythiophene) (PEDOT). The design may also include hybrid materials, such as a combination of conductive polymers and conducting oxides, or the design may also include dilute amounts of conductive fillers, such as silver whiskers or flakes, or exotic materials such as nanotubes and graphene. In some cases, the substrate 102 comprises a rigid light-transmissive material such as glass or transparent polycarbonate or acrylic.

Typically, a coating of the electro-optic medium 106, which can be switched between optical states, is applied over the electrically-conductive layer 104, such that the electro-optic medium 106 is in close proximity to the electrically-conductive layer 104. The electro-optic medium 106 will typically feature an electrophoretic material including a plurality of electrically-charged particles disposed in a fluid and capable of moving through the fluid under the influence of an electric field. The electrophoretic material can be selected such that the front panel laminate interchangeably and reversibly achieves different states when an appropriate electric field is applied, e.g., the electrophoretic medium may switch between clear and opaque, or color 1 and color 2, or clear and color 1 and color 2.

The electro-optic medium 106 may be in the form of an oppositely charged dual particle encapsulated medium. Such encapsulated media includes numerous small capsules, each of which itself comprises an internal phase containing electrophoretically-mobile particles suspended in a liquid suspension medium, and a capsule wall surrounding the internal phase. Typically, the capsules are themselves held within a polymeric binder to form a coherent layer. When the coherent layer is positioned between two electrodes the optical states can be reversed with the presentation of a suitable electric field. The suspension medium may contain a hydrocarbon-based liquid in which are suspended negatively charged white particles and positively charged black particles. Upon application of an electrical field across the electro-optic medium, the white particles move to the positive electrode and the black particles move to the negative electrode, e.g., so that the electro-optic medium 106 appears, to an observer viewing the display through the substrate 102, white or black depending upon whether the electrically-conductive layer 104 is positive or negative relative to the backplane at any point within the final display. The electro-optic medium 106 may alternatively comprise a plurality of colored particles in addition to black and/or white particles, each color having its respective charge polarity and strength. While not shown in the figures, a microcell-type medium of the type discussed above could also be used as the electro-optic medium 106.

A layer of lamination adhesive 108 is coated over the electro-optic medium layer 106, and a release sheet 110 is applied over the adhesive layer 108. The release sheet 110 may be of any known type, provided of course that it does not contain materials that adversely affect the properties of the electro-optic medium. Numerous suitable types of release sheets will be known to those skilled in the art. Common release sheets comprise a substrate such as paper or a plastic film, e.g., a PET film that is approximately about 150 μm to about 200 μm in thickness and coated with a low surface energy material such as silicone. In some instances, the release sheet is metalized to allow for application of a potential across the electro-optic medium so that functionality can be assessed during assembly of a downstream product.

The electro-optic display 114 of FIG. 1 is assembled by removing the release sheet 110 on the frontplane laminate 100 and contacting the adhesive layer 108 with the backplane 112 under conditions effective to cause the adhesive layer 108 to adhere to the backplane 112, thereby securing the adhesive layer 108, layer of electro-optic medium 106, and light-transmissive electrically-conductive layer 104 to the backplane 112. The frontplane laminate 100 can be cut larger than the final display size and could even be a continuous sheet as in a roll-to-roll process. This allows for coarse tolerances in alignment of the frontplane laminate 100 and backplane 112, which is especially helpful for large displays. Once laminated, the display can be cut to its final size, potentially using alignment marks or pins on the backplane to allow for precisely aligning the cut to the backplane.

Segmented display devices include a driver die or integrated circuit (IC) for selectively applying voltages to the display segment electrodes to drive the respective associated portions of the encapsulated electrophoretic medium between different optical states. The driver die or IC is connected to the backplane substrate often on a tail folded behind the electroactive area.

Segmented display devices include barrier edge seals to prevent ingress of moisture and other contaminants around the outer edges of the display. Pinched seals and dispensed seals are two commonly used types of edge seals used in electrophoretic displays. Pinched edge seals have a lower cost and are typically used in segmented displays, where the backplane substrate extends all the way to the outer edge of the seal. Pinched edge seals reduce the size of the air gap at the edge of the frontplane laminate. However, the substrate is typically more permeable than the barrier, which necessitates use of a wider edge seal.

Prior art segmented electrophoretic displays having display segment electrodes patterned on a backplane substrate laminated using an adhesive to the frontplane laminate have significantly reduced flexibility due to the bulk added to the structure by the backplane substrate and the laminate adhesive.

Additionally, to provide a flexural neutral axis to the electrophoretic media near the front electrode, additional compensating layers may need to be added to the front viewing side of the device. This adds further stiffness and may require compromises with other front side requirements such as protective sealing. As a result, prior art devices often have multiple delicate barrier and conductor layers spaced apart by other layers within the display stack, requiring careful mechanical design and a larger minimum bend radius.

Another disadvantage of prior art segmented displays relates to the backplane fabrication process. Screen printing of electrodes, which is commonly used for low cost backplanes, is cost effective at high production volumes, but the setup cost and lead time are not suitable for small quantity prototypes. Rigid printed etched copper circuits are more costly and may be difficult to use with thin adhesive layers needed for the display.

These and other deficiencies of the prior art are overcome by a flexible segmented electrophoretic display in which display segment electrodes of the display are directly printed adjacent the electroactive layer. This eliminates the need for a backplane substrate and adhesive between the electroactive layer and the display segment electrodes, thereby reducing the thickness of the device and improving its flexibility.

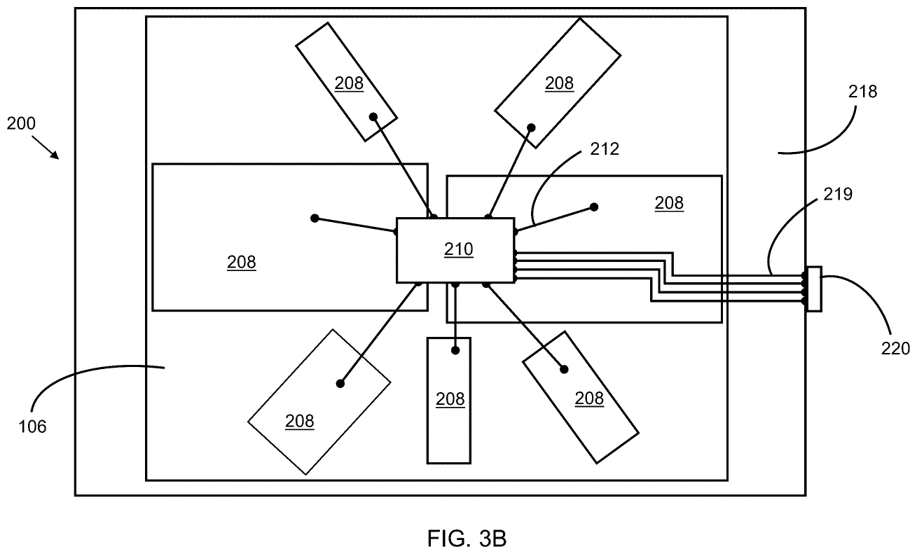

FIGS. 3A and 3B schematically illustrate an exemplary flexible segmented electrophoretic display 200 in accordance with one or more embodiments. FIG. 3A is a cross-section view of the device 200, and FIG. 3B is a plan view of selected components of the device 200. The display 200 includes an electroactive layer 106 comprising an encapsulated electrophoretic medium, similar to the electroactive layers previously discussed. The electroactive layer 106 can comprise a plurality of microcells filled with an electrophoretic fluid and sealed by a sealing layer. The electroactive layer 106 can alternatively comprise a plurality of microcapsules containing the electrophoretic fluid and dispersed in a polymer binder.

A light transmissive common electrode layer 202 is superposed on the front viewing side of the electroactive layer. By way of example, the light transmissive common electrode layer 202 comprises a flexible substrate 204 (e.g., a plastic film such as PET) with an ITO or other similar conductive coating 206, which acts as a top common electrode of the display 200.

A plurality of display segment electrodes 208 (i.e., pixel electrodes) are formed on the opposite rear side of the electroactive layer 106. The plurality of display segment electrodes 208 are directly adjacent the rear side of the electroactive layer 106, without any substrate or adhesive layer therebetween to reduce bulk in the structure and to increase flexibility. Each of the display segment electrodes 208 are associated with an adjacent portion of the encapsulated electrophoretic medium.

In one or more embodiments, the display segment electrodes 208 are printed directly on the electroactive layer 106 using inkjet or screen printing processes. The display segment electrodes 208 can comprise various conductive materials including conductive carbon.

A variety of low cure or dry temperature inks and quick cure or dry processes (e.g., using photonic sintering) can be used for safely printing the display segment electrodes 208 directly on the electroactive layer 106.

A processor or driver die 210 is electrically connected to each of the plurality of display segment electrodes 208 to apply voltages to selected display segment electrodes 208 to drive the respective associated portions of the encapsulated electrophoretic medium among different optical states. The processor die 210 is connected to each of the display segment electrodes 208 by interconnects 212. In one or more embodiments, the interconnects 212 comprise printed conductive ink. In one or more embodiments, the interconnects 212 comprise conductive carbon, silver, or copper. In one or more embodiments, the interconnects 212 are printed using high resolution printing processes such as aerosol inkjet or impulse printing processes.

A protective seal encapsulates the device components for preventing or inhibiting ingress of moisture or contaminants. In the FIG. 3A embodiment, the protective seal comprises a rear protective seal 214 facing the rear side of the electroactive layer 106 and a front protective seal 216 facing the opposite front viewing side of the electroactive layer 106. An edge protective seal 218 covers the periphery of the device 200 extending between the front and rear seals 214, 216. In one or more embodiments, the protective seal comprises a low water vapor transmission rate (WVTR) edge seal resin.

The display 200 further comprises interconnects 219 electrically connecting the processor die 210 to power and control input contacts 220 at an edge of the protective seal. The interconnects 219 can comprise conductive carbon, silver, or copper. In one or more embodiments, the power and control input contacts 220 comprise power, ground, data, and clock inputs.

A dielectric layer 222 is printed with multiple layers to ramp up around the processor die 210 to electrically insulate the processor die 210 from the display segment electrodes 208.

The display 200 further comprises an encapsulant 224 between the protective seal and the processor die 210 and the interconnects 212, 219. The encapsulant 224 protects components of the device 200, especially the printed circuit layers. In addition, the encapsulant 224 acts as a pressure sensitive adhesive for laminating the rear protective seal 214.

In one or more embodiments, the processor die 210 is mounted on a flexible carrier film providing a fanout of processor die 210 connections to facilitate electrical connections to the display segment electrodes 208.

In one or more embodiments, the display 200 further comprises a color filter array (CFA) or other graphic overlay 226 between the electroactive layer 106 and the light transmissive common electrode layer 202. The CFA 226 comprises an array of color filters, which can be placed over a black and white electroactive layer 106 to render color images.

The processor die 210 for driving the electroactive layer 106 is connected to and in close proximity to the display segment electrodes 208. Having the processor die 210 within the protective seal avoids the need for a connector to connect the display segment electrodes 208 to an external processor. This allows having a higher number of display segment electrodes 208 because having many display segment electrodes in a prior art display would require a high pin-count connector. However, high pin-count connectors may be too wide for many applications. For instance, such connectors typically have a 0.5 mm or wider pitch. Thus, a 100 pin connector may have an excessively large width of at least 50 mm. In addition, such connectors are expensive and a potential source of reliability problems.

In one or more embodiments, the processor die 210 comprises a thin die having a thickness of less than 100 um, preferably less than 50 um. For example, the die 210 can have a thickness of about 40 um. The thin processor die 210 makes it possible to laminate the rear protective seal 214 over the die 210 with substantially no air gap surrounding the die 210. Alternatively a thicker die 210 can be attached to the display segment electrodes 208 using a standard flip-chip bonding process and encapsulated with low WVTR edge seal resin. Flip-chip bonding can be performed using standard anisotropic adhesives. Thin or thick processor dies 210 can also be secured to a flexible carrier film that provides a fanout from fine pitch die connections to a print-compatible coarse pitch.

The flexible segmented electrophoretic display 200 of FIGS. 3A and 3B having a dispensed edge seal 218 can be constructed using the following exemplary process in accordance with one or more embodiments:

1. If the device 200 is to include an optional CFA or other graphic overlay 226, print the CFA or graphic overlay 226 on the conductive side of a light transmissive common electrode layer 202 (e.g., on the ITO side of a PET/ITO layer 202).

2. Form the electroactive layer 106 comprising an encapsulated electrophoretic medium on CFA or graphic overlay 226 on the light transmissive common electrode layer 202. If the electroactive layer 106 comprises electrophoretic microcapsules, coat the CFA or graphic overlay 226 with a slurry containing the microcapsules and polymer binder. If the electroactive layer 106 comprises a sealed array of microcells containing the electrophoretic fluid, form the electroactive layer 106 by (i) embossing microcells on a polymeric film deposited on the CFA or graphic overlay; (ii) filling the microcells with an electrophoretic fluid; and (iii) sealing the microcells with a polymeric sealing layer.

3. Apply the front viewing side protective seal layer 216 on a front side of the light transmissive common electrode layer 202 opposite the CFA or graphic overlay 226. This can be performed as follows:
(a) Coat or laminate a protective seal adhesive 215 to the front side of the light transmissive common electrode layer 202.
(b) Cut the laminate comprising the electroactive layer 106, the light transmissive common electrode layer 202, and the protective seal adhesive layer 215 to a size designed to fit in a desired active area.
(c) Clean a top plane connection (TPC).
(d) Laminate the front viewing side protective seal 216 to the protective seal adhesive 215.

4. Print the display segment electrodes 208 directly adjacent a side of the electroactive layer 106 opposite the light transmissive common electrode layer 202 using, e.g., conductive carbon ink. Prior to this step, a primer layer can optionally be applied to the electroactive layer 106 to improve print resolution by controlling surface energy, polarity, and roughness.

5. Bond the processor die 210 proximate to the plurality of display segment electrodes 208 with the die bumps up (i.e., the die bumps 230 are on the side of the die 210 opposite the display segment electrodes 208).

6. Print the dielectric layer 222 with multiple layers to ramp up around processor die 210.

7. Print the interconnects 212 electrically connecting the processor die bumps 230 to each of the display segment electrodes 208 using a conductive material, e.g., a conductive carbon, silver, or copper ink.

8. Deposit an encapsulant 224 over the processor die 210 and the interconnects 212 to protect the printed circuit layers and to act as a pressure sensitive adhesive for laminating the rear protective seal 214.

9. Apply the rear protective seal 214 layer over the encapsulant 224.

10. Apply the edge seals 218 at the peripheries of the viewing side protective seal layer and the rear side protective seal layer using a standard dispensing process.

11. Trim the front protective seal 216 to a final size if it was initially oversized for ease of handling.

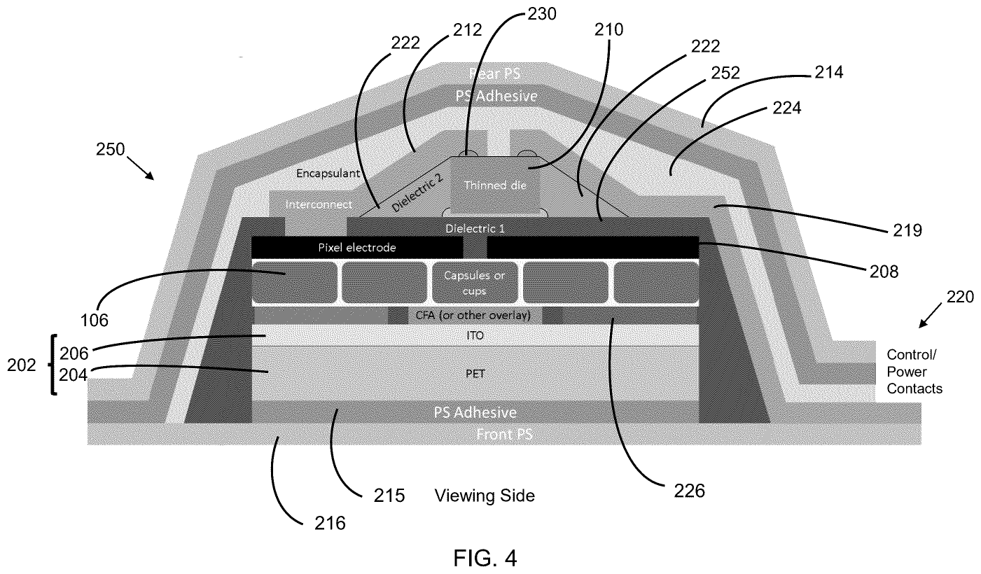

FIG. 4 is a cross-section view schematically illustrating an exemplary flexible segmented electrophoretic display 250 in accordance with one or more further embodiments. The display 250 includes a pinched edge seal instead of the side edge seals 218 of the display 200 depicted in FIGS. 3A and 3B.

The display 250 of FIG. 4 can be constructed using the following exemplary process in accordance with one or more embodiments:

1. If the device 250 is to include an optional CFA or other graphic overlay 226, print the CFA or graphic overlay 226 on the conductive side of a light transmissive common electrode layer 202 (e.g., on the ITO side of a PET/ITO layer 202).

2. Form the electroactive layer 106 comprising an encapsulated electrophoretic medium on CFA or graphic overlay 226 on the light transmissive common electrode layer 202. If the electroactive layer 106 comprises electrophoretic microcapsules, coat the CFA or graphic overlay 226 with a slurry containing the microcapsules and polymer binder. If the electroactive layer 106 comprises a sealed array of microcells containing the electrophoretic fluid, form the electroactive layer 106 by (i) embossing microcells on a polymeric film; (ii) filling the microcells with an electrophoretic fluid; and (iii) sealing the microcells with a polymeric sealing layer.

3. Apply the front viewing side protective seal layer 216 on a front side of the light transmissive common electrode layer 202 opposite the CFA or graphic overlay 226. This can be performed as follows:
(a) Coat or laminate a protective seal adhesive 215 to the front side of the light transmissive common electrode layer 202.
(b) Clean a top plane connection (TPC).
(c) Laminate the front viewing side protective seal 216 to the protective seal adhesive 215.

4. Print the display segment electrodes 208 directly adjacent a side of the electroactive layer 106 opposite the light transmissive common electrode layer 202 using, e.g., conductive carbon ink. Prior to this step, a primer layer can optionally be applied to the electroactive layer 106 to improve print resolution by controlling surface energy, polarity, and roughness.

5. Print a first dielectric layer 252 with multiple layers to ramp down around the laminate including the CFA overlay 226, the electroactive layer 106, the display segment electrodes 208, and the light transmissive common electrode layer 202.

6. Bond the processor die 210 proximate to the plurality of display segment electrodes 208 with the die bumps 230 up (i.e., the die bumps 230 are on the side of the die 210 opposite the display segment electrodes 208).

7. Print a second dielectric layer 222 with multiple layers to ramp up around the processor die 210.

8. Print the interconnects 212 electrically connecting the processor die bumps 230 to each of the display segment electrodes 208 using a conductive material, e.g., a conductive carbon, silver, or copper ink.

9. Deposit an encapsulant 224 over the processor die 210 and the interconnects 212 to protect the printed circuit layers and to act as a pressure sensitive adhesive for laminating the rear protective seal 214.

10. Apply the rear protective seal layer 214 over the encapsulant 224.

11. Trim the front protective seal 216 to a final size if it was initially oversized for ease of handling.

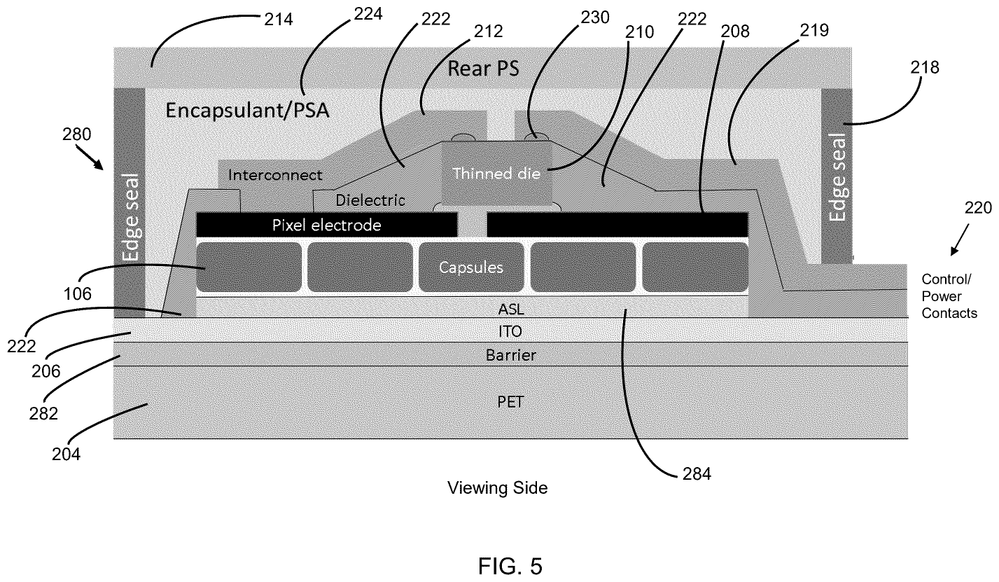

FIG. 5 is a cross-section view schematically illustrating an exemplary flexible segmented electrophoretic display 280 in accordance with one or more further embodiments. Instead of having a front protective seal layer 216 as in FIGS. 3A and 4, the device 280 includes a barrier layer 282 integrated in the light transmissive common electrode layer 202 (e.g., between the ITO layer 206 the PET layer 204). The integrated front barrier reduces the overall film stack thickness. The device 280 shown in FIG. 5 also includes a dispensed edge seal 218 similar to the edge seals 218 of the device shown in FIG. 3A. Although not shown, a similar device with an integrated front barrier can be constructed with a pinched edge seal similar to the device shown in FIG. 4.

The display 280 of FIG. 5 can be constructed using the following exemplary process in accordance with one or more embodiments:

1. Deposit the electroactive layer 106 comprising an encapsulated electrophoretic medium on a release film. If the electroactive layer 106 comprises electrophoretic microcapsules, coat the release film with a slurry containing the microcapsules and polymer binder. If the electroactive layer 106 comprises a sealed array of microcells containing the electrophoretic fluid, form the electroactive layer 106 by (i) embossing microcells on a polymeric film deposited on the release film; (ii) filling the microcells with an electrophoretic fluid; and (iii) sealing the microcells with a polymeric sealing layer.

2. Laminate an air side laminate (ASL) adhesive 284 to a side of the electroactive layer 106 opposite the release film.

3. Cut electroactive layer 106 with the release film and ASL adhesive to fit a desired active area.

4. Remove the release film from the electroactive layer 106 and laminate the electroactive layer 106 to one side of a conductive integrated barrier layer using the ASL adhesive 284.

5. Clean a top plane connection (TPC).

6. Print the display segment electrodes 208 directly adjacent a side of the electroactive layer 106 opposite the conductive integrated barrier layer 282 using, e.g., conductive carbon ink. Prior to this step, a primer layer can optionally be applied to the electroactive layer 106 to improve print resolution by controlling surface energy, polarity, and roughness.

7. Bond the processor die 210 proximate to the plurality of display segment electrodes 208 with the die bumps up (i.e., the die bumps 230 are on the side of the die 210 opposite the display segment electrodes 208).

8. Print the dielectric layer 222 with multiple layers to ramp up around processor die 210.

9. Print the interconnects 212 electrically connecting the processor die bumps 230 to each of the display segment electrodes 208 using a conductive material, e.g., a conductive carbon, silver, or copper ink.

10. Deposit an encapsulant 224 over the processor die 210 and the interconnects 212 to protect the printed circuit layers and to act as a pressure sensitive adhesive for laminating the rear protective seal 214.

11. Apply the rear protective seal layer 214 over the encapsulant 224.

12. Apply the edge seals 218 at the peripheries of the conductive integrated barrier layer and the rear side protective seal layer using a standard dispensing process.

As described above, flexible segmented electro-optic displays in accordance with various embodiments include display segment electrodes 208 that are printed directly adjacent a side of the electroactive layer 106. A significant advantage of this structure is the elimination of any lamination adhesive or substrate between the display segment electrodes 208 and the electroactive layer 106. In some embodiments, all adhesives are eliminated around the electroactive layer 106. This reduces the overall thickness of the device, which has the benefit of minimizing elongation and compression of the delicate conductor and barrier coatings when the device is flexed. This, in turn, makes the overall mechanical design of the device stack more forgiving.

Flexible segmented electro-optic displays in accordance with various embodiments can also have a larger number of display segments while using small connectors, e.g., connectors with as few as two wires (see, e.g., U.S. Pat. No. 6,459,363 for a description of how two wires can be used for data and power transmission), or more typically four wires (PWR, GND, DATA, CLK), rather than the typical configuration with a wire connection for each and every display segment 208.

Another advantage of flexible segmented electrophoretic displays in accordance with various embodiments is that they can be manufactured without precision lamination alignment. This can be a significant advantage, particularly during the early prototype stage of a project. Precision alignment for printing can be accomplished for the printing steps using optical fiducials and pattern recognition commonly used in research and production grade printers.

Another advantage of the methods of manufacturing flexible segmented electrophoretic displays in accordance with various embodiments is that they are tooling-free. This substantially reduces the up-front investment and engineering time on mechanical design, particularly at an early prototype stage of a project.

Another advantage of the methods disclosed herein is that the printing processes used in producing the displays comprise additive manufacturing processes, which produce minimal material waste. Further material waste reduction can be achieved, e.g., by direct printing of adhesives on surfaces, rather than using adhesives previously coated on a release.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A method of constructing a flexible segmented electrophoretic display, comprising the steps of:
(a) forming an electroactive layer comprising an encapsulated electrophoretic medium on one side of a light transmissive common electrode layer;
(b) applying a viewing side protective seal layer on an opposite side of the light transmissive common electrode layer;
(c) depositing a plurality of display segment electrodes directly adjacent a side of the electroactive layer opposite the light transmissive common electrode layer, wherein each of said display segment electrodes is associated with an adjacent portion of the encapsulated electrophoretic medium;
(d) bonding a processor die proximate to the plurality of display segment electrodes;
(e) depositing interconnects electrically connecting the processor die to each of said plurality of display segment electrodes to enable the processor die to selectively apply voltages to the display segment electrodes to drive the respective associated portions of the encapsulated electrophoretic medium among different optical states; and
(f) applying a rear protective seal layer over the processor die and the interconnects such that the rear protective seal layer and the viewing side protective seal layer encapsulate the electroactive layer, the light transmissive common electrode layer, the plurality of display segment electrodes, the interconnects, and the processor die.

2. The method of claim 1, wherein the electroactive layer comprises (i) an array of microcells filled with an electrophoretic fluid and sealed by a sealing layer, or (ii) a plurality of microcapsules dispersed in a polymer binder, said microcapsules containing the electrophoretic fluid.

3. The method of claim 1, further comprising forming a color filter array on said one side of the light transmissive common electrode layer prior to step (a).

4. The method of claim 1, further comprising depositing a dielectric layer over selected portions of the display segment electrodes, prior to step (d).

5. The method of claim 1, further comprising depositing an encapsulant over the processor die and the interconnects prior to step (f).

6. The method of claim 1, further comprising forming an edge seal at the peripheries of the viewing side protective seal layer and the rear side protective seal layer to inhibit ingress of moisture or contaminants, wherein forming the edge seal comprises (i) applying a seal at the periphery of the display extending between the viewing side protective seal layer and the rear side protective seal layer, or (ii) pinching together peripheral edges of the viewing side protective seal layer and the rear side protective seal layer.

7. The method of claim 1, wherein the plurality of display segment electrodes are deposited directly on the rear side of the electroactive layer without any substrate or adhesive therebetween.

8. A flexible segmented electrophoretic display constructed according to the method of claim 1.

9. A method of constructing a flexible segmented electrophoretic display, comprising the steps of:
(a) forming an electroactive layer comprising an encapsulated electrophoretic medium on one side of a conductive integrated barrier layer;
(b) depositing a plurality of display segment electrodes directly adjacent a side of the electroactive layer opposite the conductive integrated barrier layer, wherein each of said display segment electrodes is associated with an adjacent portion of the encapsulated electrophoretic medium;
(c) bonding a processor die proximate to the plurality of display segment electrodes;
(e) depositing interconnects electrically connecting the processor die to each of said plurality of display segment electrodes to enable the processor die to selectively apply voltages to the display segment electrodes to drive the respective associated portions of the encapsulated electrophoretic medium among different optical states; and
(d) applying a rear protective seal layer over the processor die and the interconnects such that the rear protective seal layer and the integrated barrier layer encapsulate the electroactive layer, the plurality of display segment electrodes, the interconnects, and the processor die.

10. The method of claim 9, wherein the conductive integrated barrier layer comprises a light-transmissive conductive material combined with a flexible moisture barrier.

11. The method of claim 9, further comprising forming a color filter array on said one side of the conductive integrated barrier layer prior to step (a).

12. The method of claim 9, wherein the plurality of display segment electrodes are deposited directly on the rear side of the electroactive layer without any adhesive or substrate therebetween.

13. A flexible segmented electrophoretic display, comprising:
an electroactive layer having a front viewing side and an opposite rear side, said electroactive layer comprising an encapsulated electrophoretic medium;
a light transmissive common electrode layer superposed on the front viewing side of the electroactive layer;
a plurality of display segment electrodes directly adjacent the rear side of the electroactive layer, each of said display segment electrodes associated with an adjacent portion of the encapsulated electrophoretic medium;
a processor die electrically connected to each of said plurality of display segment electrodes to apply voltages to selected display segment electrodes to drive the respective associated portions of the encapsulated electrophoretic medium among different optical states; and
a protective seal encapsulating the electroactive layer, the light transmissive common electrode layer, the plurality of display segment electrodes, and the processor die.

14. The display of claim 13, wherein the encapsulated electrophoretic medium comprise an electrophoretic medium encapsulated in microcapsules dispersed in a polymer binder or contained in sealed microcells.

15. The display of claim 13, wherein the processor die has a thickness of less than 100 um.

16. The display of claim 13, wherein the processor die is mounted on a flexible carrier film providing a fanout of processor die connections to facilitate electrical connections to the display segment electrodes.

17. The display of claim 13, wherein the protective seal comprises a rear protective seal facing the rear side of the electroactive layer and a front protective seal facing the front viewing side of the electroactive layer, wherein the front protective seal and the rear protective seal form barrier edge seal for inhibiting ingress of moisture or contaminants.

18. The display of claim 13, further comprising a color filter array between the electroactive layer and the light transmissive common electrode layer.

19. The display of claim 13, further comprising a dielectric layer formed selectively over the display segment electrodes, and wherein the processor die is bonded on the dielectric layer.

20. The display of claim 13, wherein the plurality of display segment electrodes are directly on the rear side of the electroactive layer without any adhesive layer or substrate therebetween.
